(19) United States
(12) Patent Application Publication
(10) Pub. No.: US 2019/0005013 A1
(43) Pub. Date: Jan. 3, 2019

(54) CONVERSATION SYSTEM-BUILDING METHOD AND APPARATUS BASED ON ARTIFICIAL INTELLIGENCE, DEVICE AND COMPUTER-READABLE STORAGE MEDIUM

(71) Applicant: BEIJING BAIDU NETCOM SCIENCE AND TECHNOLOGY CO., LTD., Haidian District Beijing (CN)

(72) Inventors: Jingjing ZHANG, Haidian District (CN); Ju WANG, Haidian District (CN); Ke SUN, Haidian District (CN)

(73) Assignee: BEIJING BAIDU NETCOM SCIENCE AND TECHNOLOGY CO., LTD., Haidian District Beijing (CN)

(21) Appl. No.: 16/019,153

(22) Filed: Jun. 26, 2018

(30) Foreign Application Priority Data
Jun. 28, 2017 (CN) 2017105074950

(51) Int. Cl. G06F 17/24; G06F 17/27; G06N 5/02

(52) U.S. Cl. CPC G06F 17/241; H04L 51/04; G06N 5/02; G06F 17/2785

(57) ABSTRACT

The present disclosure provides a conversation system building method and apparatus based on artificial intelligence, a device and a computer-readable storage medium. In embodiments of the present disclosure, the user only needs to intervene the annotation operation of the conversation samples in the case that the conversation system is not satisfied with the recognition parameters of the input information provided by the user, without manually participating in the annotation operations of all conversation samples. The operations are simple, the correctness rate is high, and thereby the efficiency and reliability of building the conversation system is improved.

The present application claims the priority of Chinese Patent Application No. 201710507495.0, filed on Jun. 28, 2017, with the title of “Conversations system-building method and apparatus based on artificial intelligence, device and computer-related storage medium”. The disclosure of the above applications is incorporated herein by reference in its entirety.

### FIELD OF THE DISCLOSURE

The present disclosure relates to human-machine conversation technologies, and particularly to a conversation system-building method and apparatus based on artificial intelligence, a device and a computer-readable storage medium.

### BACKGROUND OF THE DISCLOSURE

Artificial intelligence AI is a new technical science for researching and developing theories, methods, technologies and application systems for simulating, extending and expanding human intelligence. Artificial intelligence is a branch of computer sciences and attempts to learn about the essence of intelligence, and produces a type of new intelligent machines capable of responding in a manner similar to human intelligence. The studies in the field comprise robots, language recognition, image recognition, natural language processing, expert systems and the like.

In recent years, the concept “conversation as platform” increasingly wins support among the people. Many Internet products and industries begin to attempt to introduce a conversation-type human-machine interaction manner (also called a conversation robot) into products, for example, household electrical appliance, finance, and medical care. Correspondingly, demands for developing conversation robots also become stronger and stronger.

Currently, manually-annotated conversation samples may usually be employed to build the conversation system employed by the conversation robot. Then, this building manner completely with the manually-annotated conversation samples requires a long operation duration and probably causes errors, and thereby causes reduction of the efficiency and reliability of the conversation system.

### SUMMARY OF THE DISCLOSURE

A plurality of aspects of the present disclosure provide a conversation system building method and apparatus based on artificial intelligence, a device and a computer-readable storage medium, to improve the efficiency and reliability of the conversation system.

According to an aspect of the present disclosure, there is provided a conversation system building method based on artificial intelligence, comprising:

obtaining a sample adjusting instruction of a conversation system triggered by a user, the sample adjusting instruction being triggered by the user according to the conversation system's recognition parameters for input information provided by the user;

according to the sample adjusting instruction, outputting at least one adjustment option for the user to select;

according to the adjustment option selected by the user, outputting an adjustment interface to obtain adjustment information provided by the user based on the adjustment interface;

obtaining an adjustment parameter of the conversation service according to the adjustment information;

performing data annotation processing according to the input information and the adjustment parameter of the conversation system, to obtain conversation samples for building the conversation system.

The above aspect and any possible implementation mode further provide an implementation mode: before obtaining a sample adjusting instruction triggered by a user, the method further comprises:

obtaining input information provided by the user to perform the conversation service with the conversation system;

outputting the input information;

according to the input information, obtaining recognition parameters of the conversation system;

outputting the recognition parameters of the conversation system.

The above aspect and any possible implementation mode further provide an implementation mode: after outputting the recognition parameters of the conversation system, the method further comprises:

outputting adjustment instruction information to instruct the user to trigger the sample adjustment instruction.

The above aspect and any possible implementation mode further provide an implementation mode: before obtaining a sample adjusting instruction triggered by a user, the method further comprises:

obtaining application scenario information of a conversation service scenario provided by the developer, the application scenario information including intent information, parameter information and corresponding execution actions;

building the conversation system having a basic service logic, according to the application scenario information.

The above aspect and any possible implementation mode further provide an implementation mode: before, at the same time as or after obtaining a sample adjusting instruction triggered by a user, the method further comprises:

obtaining verification effect data of the conversation system according to the input information;

outputting the verification effect data.

The above aspect and any possible implementation mode further provide an implementation mode: said at least one adjustment option includes a specific option for outputting a Graphical User Interface, for the user to perform global view.

According to another aspect of the present disclosure, there is provided a conversation system building apparatus based on artificial intelligence, comprising:

an interaction unit configured to obtain a sample adjusting instruction of a conversation system triggered by a user, the sample adjusting instruction being triggered by the user according to the conversation system's recognition parameters for input information provided by the user;

an output unit configured to, according to the sample adjusting instruction, output at least one adjustment option for the user to select;

the output unit is further configured to, according to the adjustment option selected by the user, output an adjustment interface to obtain adjustment information provided by the user based on the adjustment interface:

an obtaining unit configured to obtain an adjustment parameter of the conversation service according to the adjustment information;

a building unit configured to perform data annotation processing according to the input information and the adjustment parameter of the conversation system, to obtain conversation samples for building the conversation system.

The above aspect and any possible implementation mode further provide an implementation mode:

the interaction unit is further configured to obtain input information provided by the user to perform the conversation service with the conversation system;

the output unit is further configured to output the input information;

the interaction unit is further configured to, according to the input information, obtain recognition parameters of the conversation system;

the output unit is further configured to output the recognition parameters of the conversation system.

The above aspect and any possible implementation mode further provide an implementation mode: the output unit is further configured to

output adjustment instruction information to instruct the user to trigger the sample adjustment instruction.

The above aspect and any possible implementation mode further provide an implementation mode:

the interaction unit is further configured to

obtain application scenario information of a conversation service scenario provided by the developer, the application scenario information including intent information, parameter information and corresponding execution actions;

the building unit is further configured to

build the conversation system having a basic service logic, according to the application scenario information.

The above aspect and any possible implementation mode further provide an implementation mode:

the interaction unit is further configured to

obtain verification effect data of the conversation system according to the input information;

the output unit is configured to

output the verification effect data.

The above aspect and any possible implementation mode further provide an implementation mode:

at least one adjustment option includes a specific option for outputting a Graphical User Interface, for the user to perform global view.

According to a further aspect of the present disclosure, there is provided a device, wherein the device comprises:

one or more processors;

a memory for storing one or more programs,

the one or more programs, when executed by said one or more processors, enable said one or more processors to implement the conversation system building method based on artificial intelligence according to one of the above aspects.

According to another aspect of the present disclosure, there is provided a computer readable storage medium on which a computer program is stored, wherein the program, when executed by a processor, implements the conversation system building method based on artificial intelligence according to one of the above aspects.

As known from the technical solutions, in the embodiments of the present disclosure, it is feasible to obtain a sample adjusting instruction of the conversation system triggered by a user, the sample adjusting instruction being triggered by the user according to the conversation system's recognition parameters for input information provided by the user, then according to the sample adjusting instruction, output at least one adjustment option for the user to select, then according to the adjustment option selected by the user, output an adjustment interface to obtain adjustment information provided by the user based on the adjustment interface, so that it is possible to obtain an adjustment parameter of the conversation service according to the adjustment information, and perform data annotation processing according to the input information and the adjustment parameter of the conversation system, to obtain conversation samples for building the conversation system. The user only needs to intervene the annotation operation of the conversation samples in the case that the conversation system is not satisfied with the recognition parameters of the input information provided by the user, without manually participating in the annotation operations of all conversation samples. The operations are simple, the correctness rate is high, and thereby the efficiency and reliability of building the conversation system is improved.

In addition, according to the technical solutions provided by the present disclosure, the operation of collecting input information provided by the user and generating the conversion samples may be made stand alone, encapsulated as a function, and provided to many developers through a customization platform. This operation is needed by each conversation service scenario, irrelevant to the specific service logic of these conversation service scenarios, and can effectively reduce each developer's overhead for performing this function.

In addition, according to the technical solutions provided by the present disclosure, with the annotation of conversation samples being merged in the human-machine interaction, what is experienced by the user on the output interface is an effect after the products get online in the future, so that under such product design, the user's feeling of the scenario is stronger and the user's experience is better.

In addition, according to the technical solutions provided by the present disclosure, it is possible to synchronously perform annotation of conversation samples, training, namely, building of the conversation system, and verification of the conversation system, perform verification along with changes, and effectively improve the development efficiency of the conversation system.

In addition, according to the technical solution provided by the present disclosure, it is possible to synchronously record the number according to the input information provided by the user, obtain the verification effect data of the conversation system according to the recorded data, and calculate verification effect data of the conversation system such as a recall rate and an accuracy rate, to achieve effect evaluation. It is unnecessary to additionally perform multiple rounds of verification of the conversation effects purposely, and it is possible to further improve the development efficiency of the conversation system.

In addition, the technical solution provided by the present disclosure may be employed to effectively improve the user's experience.

### BRIEF DESCRIPTION OF DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be obtained from these figures without making inventive efforts.

FIG. 1A is a flow chart of a conversation system building method based on artificial intelligence according to an embodiment of the present disclosure:

FIG. 1B-FIG. 1F are schematic views of an output interface in the embodiment corresponding to FIG. 1;

FIG. 2 is a structural schematic diagram of a conversation system building apparatus based on artificial intelligence according to another embodiment of the present disclosure:

FIG. 3 is a block diagram of an example computer system/server 12 adapted to implement an embodiment of the present disclosure.

### DETAILED DESCRIPTION OF PREFERRED EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments obtained by those having ordinary skill in the art based on the embodiments of the present disclosure, without making any inventive efforts, fall within the protection scope of the present disclosure.

It needs to be appreciated that the terminals involved in the embodiments of the present disclosure comprise but are not limited to a mobile phone, a Personal Digital Assistant (PDA), a wireless handheld device, a tablet computer, a Personal Computer (PC), an MP3 player, an MP4 player, and a wearable device (e.g., a pair of smart glasses, a smart watch, or a smart bracelet).

In addition, the term “and/or” used in the text is only an association relationship depicting associated objects and represents that three relations might exist, for example, A and/or B may represents three cases, namely, A exists individually, both A and B coexist, and B exists individually. In addition, the symbol “I” in the text generally indicates associated objects before and after the symbol are in an “or” relationship.

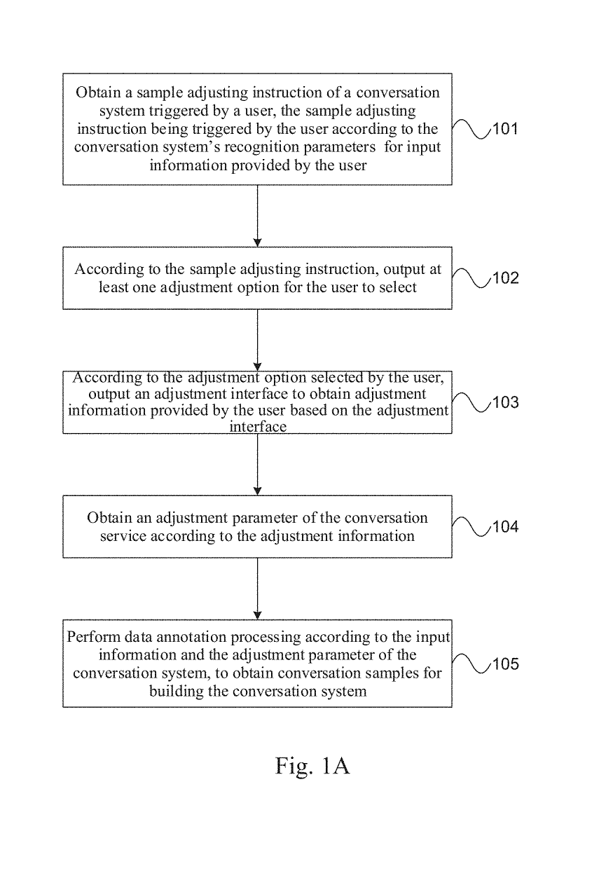

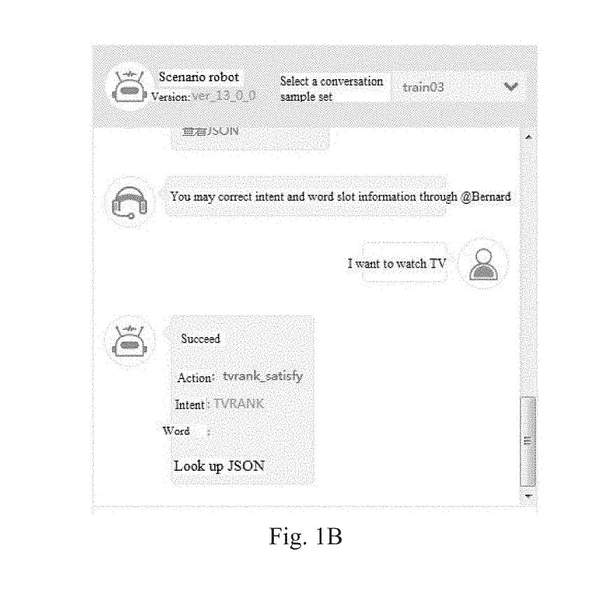

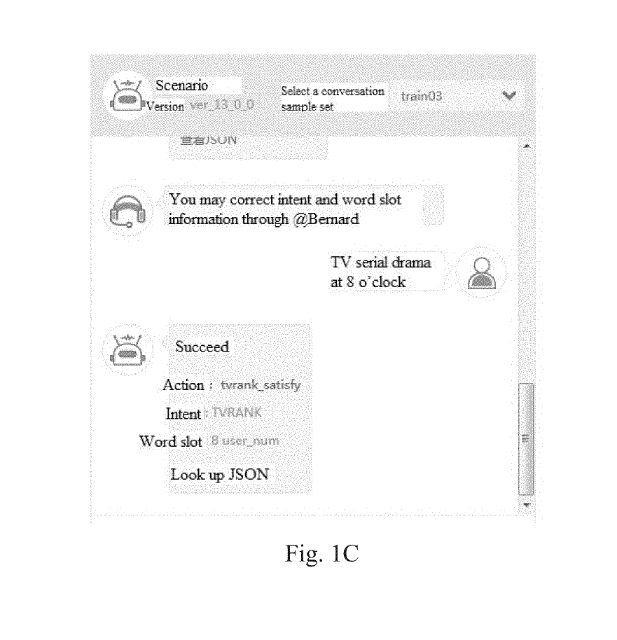

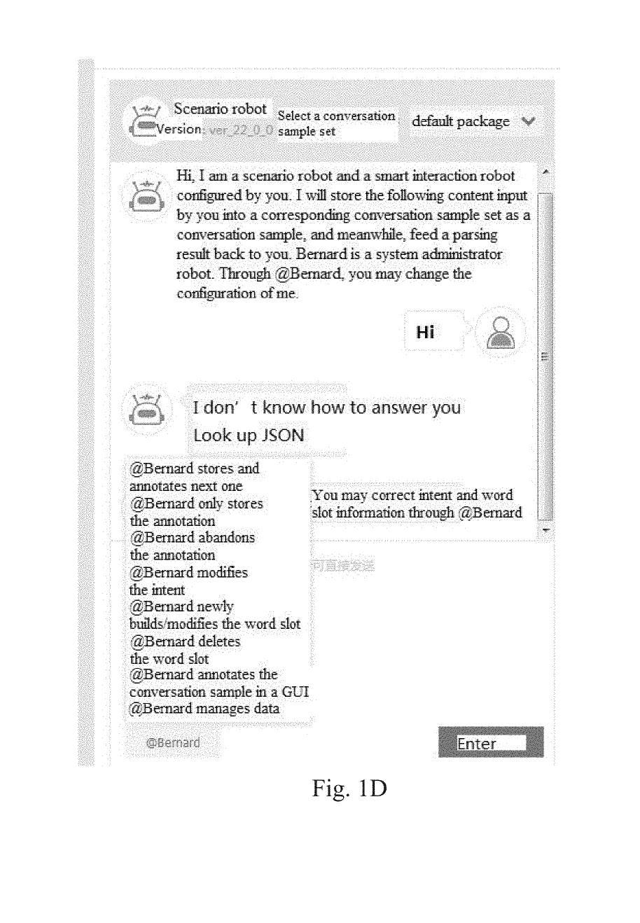

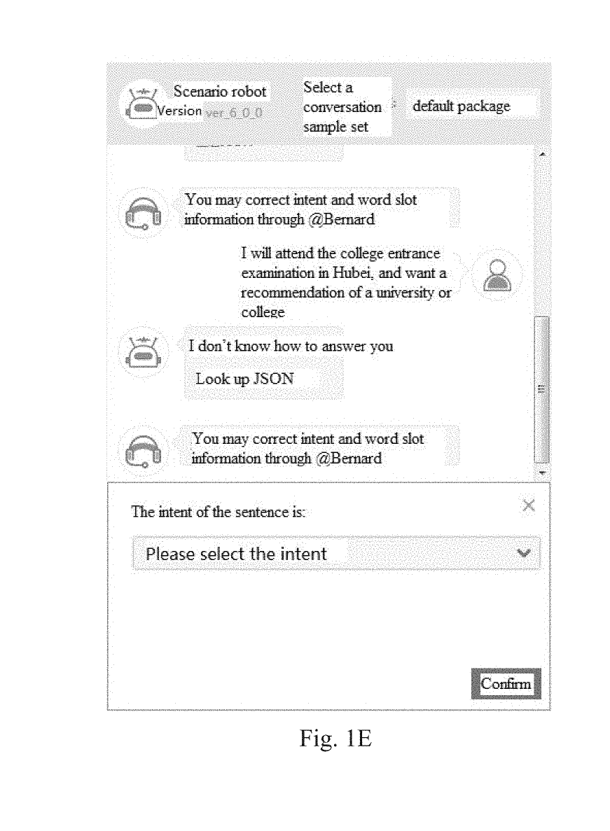

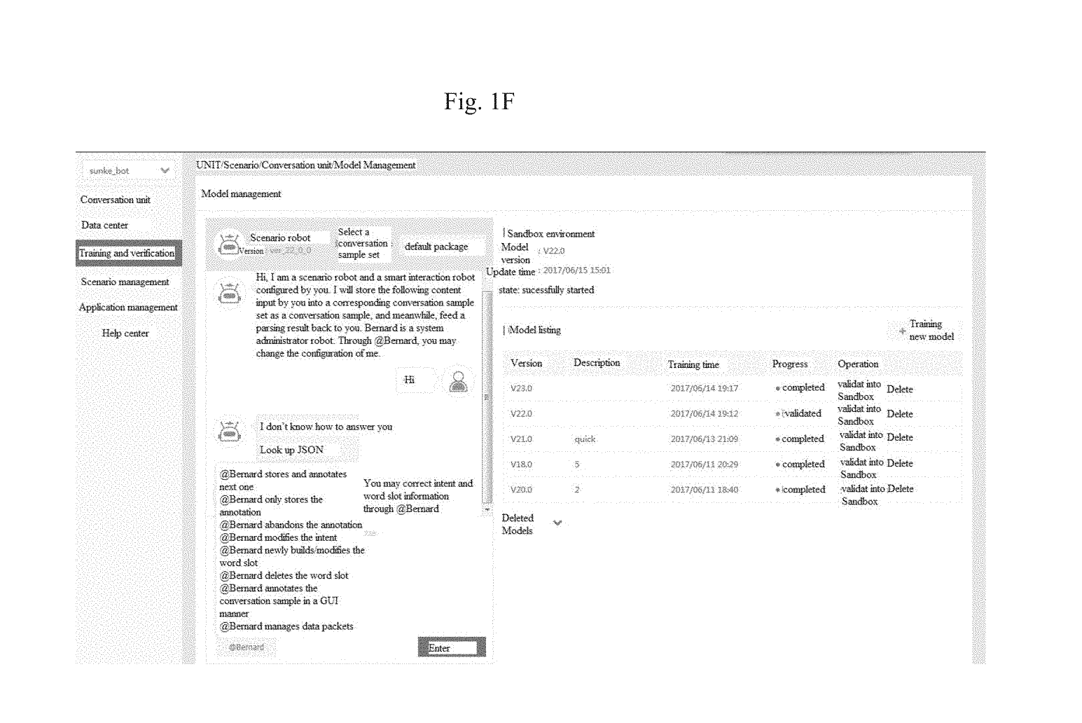

FIG. 1A is a flow chart of a conversation system building method based on artificial intelligence according to an embodiment of the present disclosure. As shown in FIG. 1A, the method comprises the following steps:
101: obtaining a sample adjusting instruction of a conversation system triggered by a user, the sample adjusting instruction being triggered by the user according to the conversation system's recognition parameters for input information provided by the user.
102: according to the sample adjusting instruction, outputting at least one adjustment option for the user to select.
103: according to the adjustment option selected by the user, outputting an adjustment interface to obtain adjustment information provided by the user based on the adjustment interface.
104: obtaining an adjustment parameter of the conversation service according to the adjustment information.
105: performing data annotation processing according to the input information and the adjustment parameter of the conversation system, to obtain conversation samples for building the conversation system.

It needs to be appreciated that subjects for executing 101-105 may partially or totally be an application located in a local terminal, or a function unit such as a plug-in or Software Development Kit (SDK) located in an application of the local terminal, or a processing engine located in a network-side server, or a distributed type system located on the network side. This is not particularly limited in the present embodiment.

It may be understood that the application may be a native application (nativeAPP) installed on the terminal, or a webpage program (webApp) of a browser on the terminal. This is not particularly limited in the present embodiment.

As such, it is feasible to obtain a sample adjusting instruction of a conversation system triggered by a user, the sample adjusting instruction being triggered by the user according to the conversation system's recognition parameters for input information provided by the user, then according to the sample adjusting instruction, output at least one adjustment option for the user to select, then according to the adjustment option selected by the user, output an adjustment interface to obtain adjustment information provided by the user based on the adjustment interface, so that it is possible to obtain an adjustment parameter of the conversation service according to the adjustment information, and perform data annotation processing according to the input information and the adjustment parameter of the conversation system, to obtain conversation samples for building the conversation system. The user only needs to intervene the annotation operation of the conversation sample in the case that the conversation system is not satisfied with the recognition parameters of the input information provided by the user, without manually participating in the annotation operations of all conversation samples. The operations are simple, the correctness rate is high, and thereby the efficiency and reliability of building the conversation system is improved.

A configuration platform of a current conversation system usually provides annotation of conversation samples, training of the conversation system and verification of the conversation system as relatively independent functions. During a developer's development, operations can only be performed in series, thereby causing a larger workload of configuring the conversation system, and a longer period of time. For example, the training of the conversation system can be performed only after conversation samples of a certain order of magnitude are annotated for a service scenario; after the conversation system is duly built, it is further necessary to perform conversation service with the conversation system to verify the effect of the conversation system.

As compared with the configuration platform of the current conversation system, the technical solution provided by the present disclosure may achieve synchronous performance of annotation of conversation samples, training, namely, building of the conversation system, and verification of the conversation system, and can perform verification along with changes, thereby reducing the time period for configuring the conversation system, saving time and manpower costs, and effectively improving the development efficiency of the conversation system.

Optionally, in a possible implementation mode of the present embodiment, before step 101, it is further feasible to obtain application scenario information of a conversation service scenario provided by the developer, the application scenario information including intent information, parameter information and corresponding execution actions, and then build the conversation system having a basic service logic, according to the application scenario information.

In the implementation mode, the developer only needs to concern the conversation logic, namely, intent and parameter, related to a specific conversation service scenario, and then define the application scenario information of the conversation service scenario. The application scenario information includes intent information, parameter information (slots) and corresponding execution actions.

Specifically, a visualized customization page may be provided so that the developer provides the application scenario information of the conversation service scenario.

For example, the provided visualized customization page may include input controls such as a definition box including the intent, for example, find a car (intent; find_car), a definition box of parameters, for example, (car; red Camero), car color (color; red), car model (model; Camero), a definition box of execution actions, and triggering rules of the execution actions. Furthermore, the visualized customization page may further include a definition box of response content, a definition box of response-triggering rules, and so on.

After the building of the conversation system having a basic service logic is completed, the conversation system may be used as an initial conversation system to perform the conversation service with the user. At this time, the user may understand it as a human trainer. During the conversation of both parties, the technical solution provided by the present disclosure may be employed to mine conversation samples which have training value, and then build the conversation system with the mined conversation samples.

Specifically, the operation of collecting input information provided by the user and generating the conversion samples may be made stand alone, encapsulated as a function, and provided to many developers through the customization platform. This operation is needed by each conversation service scenario, irrelevant to the specific service logic of these conversation service scenarios, and can effectively reduce each developer's overhead for performing this function.

Optionally, in a possible implementation mode of the present embodiment, before step 101, it is specifically feasible to obtain input information provided by the user to perform the conversation service with the conversation system, and output the input information, and then according to the input information, obtain recognition parameters of the conversation system, and output the recognition parameters of the conversation system, as shown in FIG. 1B and FIG. 1C.

While the user performs conversation service with the conversation system, the input information provided by the user may directly serve as an annotation object, and completes automatic annotation of the conversation samples during the conversation. If the user is not satisfied with the result of automatic annotation, it is feasible to further provide the user with an access for human intervention so that adjustment parameters of the conversation system provided by the user are used to perform data annotation processing for the input information, to obtain the conversation samples.

During the mining of the conversation samples, the obtained recognition parameters of the conversation system for the input information provided by the user might be inaccurate sometimes. At this time, the user may trigger a sample adjustment instruction according to the recognition parameters of the conversation system for the input information provided by the user, so that the user can synchronously complete error correction of annotation of the conversation samples during the conversation.

In the implementation mode, after the recognition parameters of the conversation system are output, it is feasible to further output adjustment instruction information to instruct the user to trigger the sample adjustment instruction, for example, “you may correct intent and word slot information through @Bernard” in FIG. 1B and FIG. 1C.

Specifically, it is feasible to build in a system assistant for the user, personalize and name it as Bernard, and use it to respond to the user's annotation adjustment demands, so that the user synchronously completes error correction of annotation of the conversation samples during the conversation. During the user's conversation with the conversation system, when the recognition parameters of the conversation system, for example, intent, word slots and the like, cannot be recognized or are recognized wrongly, the user may quickly call the system assistant according to the adjustment instruction information and through @Bernard, and modify the recognition parameter of the conversation system, namely, annotation related to the conversation samples, in time.

As such, with the annotation of conversation samples being merged in the human-machine interaction, what is experienced by the user on the output interface is an effect after the products get online in the future, so that under such product design, the user's feeling of the scenario is stronger and the user's experience is better.

Optionally, in a possible implementation mode of the present embodiment, in 102, it is specifically feasible to, according to the obtained sample adjustment instruction triggered by the user, output at least one adjustment option in the current conversation window, for selection by the user, as shown in FIG. 1D.

Optionally, in a possible implementation mode of the present embodiment, in 103, it is specifically feasible to, according the adjustment option selected by the user based on at least one adjustment option output by the current conversation window, output an adjustment interface to obtain the adjustment information provided by the user based on the adjustment interface, as shown in FIG. 1E.

Further optionally, at least one adjustment option output by the current conversation window may include a specific option. The specific option is used to output a Graphical User Interface (GUI), as shown in FIG. 1F, so that the user may perform global view and operation in conjunction with the GUI, and the GUI can help the user to more conveniently and smoothly complete relevant data work.

Optionally, in a possible implementation mode of the present embodiment, before, at the same time as or after 101, it is further feasible to obtain verification effect data of the conversation system according to the input information, and then output the verification effect data.

In this implementation mode, if input information of multiple rounds of conversation is needed to perform verification of the conversation system, it is possible to guide the user to further provide more input information to clarify recognition parameters of the conversation system such as the intent or word slots, and it is unnecessary for a man to perform multiple rounds of conversation with the conversation system.

Specifically, it is specifically feasible to synchronously record the number according to the input information provided by the user, obtain the verification effect data of the conversation system according to the recorded data, and calculate verification effect data of the conversation system such as a recall rate and an accuracy rate, to achieve effect evaluation. It is unnecessary to additionally perform multiple rounds of verification of the conversation effects purposely, and it is possible to further improve the development efficiency of the conversation system.

As such, it is possible to achieve synchronous performance of annotation of conversation samples, training, namely, building of the conversation system, and verification of the conversation system, perform verification along with changes, and effectively improve the development efficiency of the conversation system.

In the interaction form provided by the present disclosure, the user needn't use a keyboard to input specific content of a sentence, but speak out specific content of a sentence directly in the form of speech conversation, which can avoid reduction of the development efficiency of the conversation system caused by the switching between input devices such as the keyboard and a mouse.

In the present embodiment, it is feasible to obtain a sample adjusting instruction of the conversation system triggered by a user, the sample adjusting instruction being triggered by the user according to the conversation system's recognition parameters for input information provided by the user, then according to the sample adjusting instruction, output at least one adjustment option for the user to select, then according to the adjustment option selected by the user, output an adjustment interface to obtain adjustment information provided by the user based on the adjustment interface, so that it is possible to obtain an adjustment parameter of the conversation service according to the adjustment information, and perform data annotation processing according to the input information and the adjustment parameter of the conversation system, to obtain conversation samples for building the conversation system. The user only needs to intervene the annotation operation of the conversation samples in the case that the conversation system is not satisfied with the recognition parameters of the input information provided by the user, without manually participating in the annotation operations of all conversation samples. The operations are simple, the correctness rate is high, and thereby the efficiency and reliability of building the conversation system is improved.

In addition, according to the technical solution provided by the present disclosure, the operation of collecting input information provided by the user and generating the conversion samples may be made stand alone, encapsulated as a function, and provided to many developers through a customization platform. This operation is needed by each conversation service scenario, irrelevant to the specific service logic of these conversation service scenarios, and can effectively reduce each developer's overhead for performing this function.

In addition, according to the technical solution provided by the present disclosure, with the annotation of conversation samples being merged in the human-machine interaction, what is experienced by the user on the output interface is an effect after the products get online in the future, so that under such product design, the user's feeling of the scenario is stronger and the user's experience is better.

In addition, according to the technical solution provided by the present disclosure, it is possible to synchronously perform annotation of conversation samples, training, namely, building of the conversation system, and verification of the conversation system, perform verification along with changes, and effectively improve the development efficiency of the conversation system.

In addition, according to the technical solution provided by the present disclosure, it is possible to synchronously record the number according to the input information provided by the user, obtain the verification effect data of the conversation system according to the recorded data, and calculate verification effect data of the conversation system such as a recall rate and an accuracy rate, to achieve effect evaluation. It is unnecessary to additionally perform multiple rounds of verification of the conversation effects purposely, and it is possible to further improve the development efficiency of the conversation system.

In addition, the technical solution provided by the present disclosure may be employed to effectively improve the user's experience.

It needs to be appreciated that regarding the aforesaid method embodiments, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

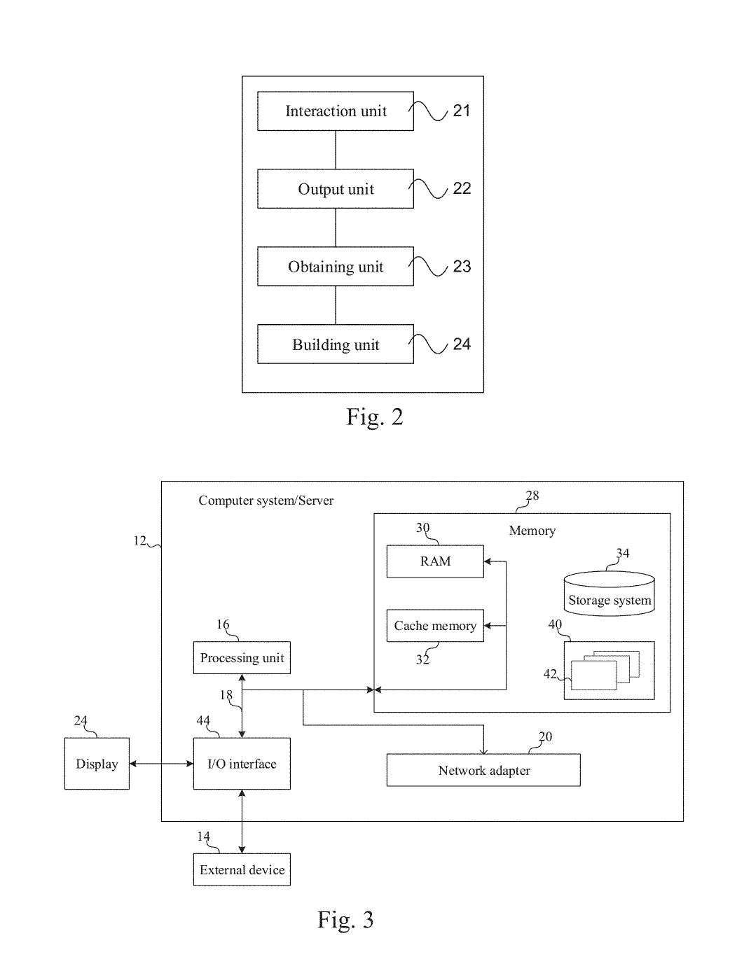

FIG. 2 is a structural schematic diagram of a conversation system building apparatus based on artificial intelligence according to another embodiment of the present disclosure. As shown in FIG. 2, the a conversation system building apparatus based on artificial intelligence according to the present embodiment comprises an interaction unit 21, an output unit 22, an obtaining unit 23 and a building unit 24, wherein the interaction unit 21 is configured to obtain a sample adjusting instruction of a conversation system triggered by a user, the sample adjusting instruction being triggered by the user according to the conversation system's recognition parameters for input information provided by the user; the output unit 22 is configured to, according to the sample adjusting instruction, output at least one adjustment option for the user to select; the output unit 22 is further configured to, according to the adjustment option selected by the user, output an adjustment interface to obtain adjustment information provided by the user based on the adjustment interface; the obtaining unit 23 is configured to obtain an adjustment parameter of the conversation service according to the adjustment information; the building unit 24 is configured to perform data annotation processing according to the input information and the adjustment parameter of the conversation system, to obtain conversation samples for building the conversation system.

It needs to be appreciated that the conversation system building apparatus based on artificial intelligence according to the present embodiment may partially or totally be an application located in a local terminal, or a function unit such as a plug-in or Software Development Kit (SDK) located in an application of the local terminal, or a search engine located in a network-side server, or a distributed type system located on the network side. This is not particularly limited in the present embodiment.

It may be understood that the application may be a native application (nativeAPP) installed on the terminal, or a webpage program (webApp) of a browser on the terminal. This is not particularly limited in the present embodiment.

Optionally, in a possible implementation mode of the present embodiment, the interaction unit 21 is further configured to obtain input information provided by the user to perform the conversation service with the conversation system, correspondingly, the output unit 22 may further be configured to output the input information; the interaction unit 21 may further configured to, according to the input information, obtain recognition parameters of the conversation system; correspondingly, the output unit 22 may further be configured to output the recognition parameters of the conversation system.

Optionally, in a possible implementation mode of the present embodiment, the output unit 22 may further be configured to output adjustment instruction information to instruct the user to trigger the sample adjustment instruction.

Optionally, in a possible implementation mode of the present embodiment, the interaction unit 21 may further be configured to obtain application scenario information of a conversation service scenario provided by the developer, the application scenario information including intent information, parameter information and corresponding execution actions; correspondingly, the building unit 21 may further be configured to build the conversation system having a basic service logic, according to the application scenario information.

Further optionally, at least one adjustment option output by the current conversation window may include a specific option. The specific option is used to output a Graphical User Interface (GUI), as shown in FIG. 1F, so that the user may perform global view and operation in conjunction with the GUI, and the GUI can help the user to more conveniently and smoothly complete relevant data work.

Optionally, in a possible implementation mode of the present embodiment, the interaction unit 21 may further be configured to obtain verification effect data of the conversation system according to the input information; correspondingly, the output unit 22 is configured to output the verification effect data.

It needs to be appreciated that the method in the embodiment corresponding to FIG. 1A may be implemented by the conversation system building apparatus based on artificial intelligence according to the present embodiment. Detailed description will not be detailed any longer here, and reference may be made to relevant content in the embodiment corresponding to FIG. 1A.

In the present embodiment, the interaction unit obtains a sample adjusting instruction of the conversation system triggered by a user, the sample adjusting instruction being triggered by the user according to the conversation system's recognition parameters for input information provided by the user; then the output unit, according to the sample adjusting instruction, outputs at least one adjustment option for the user to select, then according to the adjustment option selected by the user, outputs an adjustment interface to obtain adjustment information provided by the user based on the adjustment interface, so that the obtaining unit obtains an adjustment parameter of the conversation service according to the adjustment information, and the building unit performs data annotation processing according to the input information and the adjustment parameter of the conversation system, to obtain conversation samples for building the conversation system. The user only needs to intervene the annotation operation of the conversation samples in the case that the conversation system is not satisfied with the recognition parameters of the input information provided by the user, without manually participating in the annotation operations of all conversation samples. The operations are simple, the correctness rate is high, and thereby the efficiency and reliability of building the conversation system is improved.

In addition, according to the technical solution provided by the present disclosure, the operation of collecting input information provided by the user and generating the conversion samples may be made stand alone, encapsulated as a function, and provided to many developers through a customization platform. This operation is needed by each conversation service scenario, irrelevant to the specific service logic of these conversation service scenarios, and can effectively reduce each developer's overhead for performing this function.

In addition, according to the technical solution provided by the present disclosure, with the annotation of conversation samples being merged in the human-machine interaction, what is experienced by the user on the output interface is an effect after the products get online in the future, so that under such product design, the user's feeling of the scenario is stronger and the user's experience is better.

In addition, according to the technical solution provided by the present disclosure, it is possible to synchronously perform annotation of conversation samples, training, namely, building of the conversation system, and verification of the conversation system, perform verification along with changes, and effectively improve the development efficiency of the conversation system.

In addition, according to the technical solution provided by the present disclosure, it is possible to synchronously record the number according to the input information provided by the user, obtain the verification effect data of the conversation system according to the recorded data, and calculate verification effect data of the conversation system such as a recall rate and an accuracy rate, to achieve effect evaluation. It is unnecessary to additionally perform multiple rounds of verification of the conversation effects purposely, and it is possible to further improve the development efficiency of the conversation system.

In addition, the technical solution provided by the present disclosure may be employed to effectively improve the user's experience.

FIG. 3 is a block diagram of an exemplary computer system/server 12 adapted to implement the embodiment of the present disclosure. The computer system/server 12 shown in FIG. 3 is only an example and should not bring about any limitation to the function and range of use of the embodiments of the present disclosure.

As shown in FIG. 3, the computer system/server 12 is shown in the form of a general-purpose computing device. The components of computer system/server 12 may include, but are not limited to, one or more processors or processing units 16, a storage device or system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus. Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32.

Computer system/server 12 may further include other removable/non-removable, volatile/non-volatile computer system storage media. By way of example only, storage system 34 can be provided for reading from and writing to a non-removable, non-volatile magnetic media (not shown in FIG. 3 and typically called a “hard drive”). Although not shown in FIG. 3, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. The memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data.

Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input-Output (I/O) interfaces 44. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The processing unit 16 executes various function applications and data processing by running programs stored in the system memory 28, for example, implement the conversation system building method based on artificial intelligence according to the embodiment corresponding to FIG. 1A.

Anther embodiment of the present disclosure further provides a computer-readable storage medium on which a computer program is stored. The program, when executed by a processor, implements the conversation system building method based on artificial intelligence according to the embodiment corresponding to FIG. 1A.

Specifically, any combinations of one or more computer-readable media may be employed. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be a tangible device that can retain and store instructions for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those skilled in the art can clearly understand that for purpose of convenience and brevity of depictions, reference may be made to corresponding procedures in the aforesaid method embodiments for specific operation procedures of the system, apparatus and units described above, which will not be detailed any more.

In the embodiments provided by the present disclosure, it should be understood that the revealed system, apparatus and method can be implemented in other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk. Read-Only Memory (ROM), a Random Access Memory (RAM), magnetic disk, or an optical disk.

Finally, it is appreciated that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not cause essence of corresponding technical solutions to depart from the spirit and scope of technical solutions of embodiments of the present disclosure.

What is claimed is:

1. A conversation system building method based on artificial intelligence, wherein the method comprises:
obtaining a sample adjusting instruction of a conversation system triggered by a user, the sample adjusting instruction being triggered by the user according to the conversation system's recognition parameters for input information provided by the user;
according to the sample adjusting instruction, outputting at least one adjustment option for the user to select;
according to the adjustment option selected by the user, outputting an adjustment interface to obtain adjustment information provided by the user based on the adjustment interface;
obtaining an adjustment parameter of the conversation service according to the adjustment information;
performing data annotation processing according to the input information and the adjustment parameter of the conversation system, to obtain conversation samples for building the conversation system.

2. The method according to claim 1, wherein before obtaining a sample adjusting instruction triggered by a user, the method further comprises:
obtaining input information provided by the user to perform the conversation service with the conversation system;
outputting the input information;
according to the input information, obtaining recognition parameters of the conversation system;
outputting the recognition parameters of the conversation system.

3. The method according to claim 2, wherein after outputting the recognition parameters of the conversation system, the method further comprises:
outputting adjustment instruction information to instruct the user to trigger the sample adjustment instruction.

4. The method according to claim 1, wherein before obtaining a sample adjusting instruction triggered by a user, the method further comprises:
obtaining application scenario information of a conversation service scenario provided by the developer, the application scenario information including intent information, parameter information and corresponding execution actions;
building the conversation system having a basic service logic, according to the application scenario information.

5. The method according to claim 1, wherein before, at the same time as or after obtaining a sample adjusting instruction triggered by a user, the method further comprises:
obtaining verification effect data of the conversation system according to the input information;
outputting the verification effect data.

6. The method according to claim 1, wherein said at least one adjustment option includes a specific option for outputting a Graphical User Interface, for the user to perform global view.

7. A device, wherein the device comprises:
one or more processors;
a memory for storing one or more programs,
the one or more programs, when executed by said one or more processors, enable said one or more processors to implement a conversation system building method based on artificial intelligence, wherein the method comprises:
obtaining a sample adjusting instruction of a conversation system triggered by a user, the sample adjusting instruction being triggered by the user according to the conversation system's recognition parameters for input information provided by the user;
according to the sample adjusting instruction, outputting at least one adjustment option for the user to select;
according to the adjustment option selected by the user, outputting an adjustment interface to obtain adjustment information provided by the user based on the adjustment interface;
obtaining an adjustment parameter of the conversation service according to the adjustment information;
performing data annotation processing according to the input information and the adjustment parameter of the conversation system, to obtain conversation samples for building the conversation system.

8. The device according to claim 7, wherein before obtaining a sample adjusting instruction triggered by a user, the method further comprises:
obtaining input information provided by the user to perform the conversation service with the conversation system;
outputting the input information;
according to the input information, obtaining recognition parameters of the conversation system;
outputting the recognition parameters of the conversation system.

9. The device according to claim 8, wherein after outputting the recognition parameters of the conversation system, the method further comprises:
outputting adjustment instruction information to instruct the user to trigger the sample adjustment instruction.

10. The device according to claim 7, wherein before obtaining a sample adjusting instruction triggered by a user, the method further comprises:
obtaining application scenario information of a conversation service scenario provided by the developer, the application scenario information including intent information, parameter information and corresponding execution actions;
building the conversation system having a basic service logic, according to the application scenario information.

11. The device according to claim 7, wherein before, at the same time as or after obtaining a sample adjusting instruction triggered by a user, the method further comprises:
obtaining verification effect data of the conversation system according to the input information;
outputting the verification effect data.

12. The device according to claim 7, wherein said at least one adjustment option includes a specific option for outputting a Graphical User Interface, for the user to perform global view.

13. A computer readable storage medium on which a computer program is stored, wherein the program, when executed by a processor, implements a conversation system building method based on artificial intelligence, wherein the method comprises:
obtaining a sample adjusting instruction of a conversation system triggered by a user, the sample adjusting instruction being triggered by the user according to the conversation system's recognition parameters for input information provided by the user;
according to the sample adjusting instruction, outputting at least one adjustment option for the user to select;
according to the adjustment option selected by the user, outputting an adjustment interface to obtain adjustment information provided by the user based on the adjustment interface;
obtaining an adjustment parameter of the conversation service according to the adjustment information;
performing data annotation processing according to the input information and the adjustment parameter of the conversation system, to obtain conversation samples for building the conversation system.

14. The computer readable storage medium according to claim 13, wherein before obtaining a sample adjusting instruction triggered by a user, the method further comprises:
obtaining input information provided by the user to perform the conversation service with the conversation system;
outputting the input information;
according to the input information, obtaining recognition parameters of the conversation system;
outputting the recognition parameters of the conversation system.

15. The computer readable storage medium according to claim 14, wherein after outputting the recognition parameters of the conversation system, the method further comprises:
outputting adjustment instruction information to instruct the user to trigger the sample adjustment instruction.

16. The computer readable storage medium according to claim 13, wherein before obtaining a sample adjusting instruction triggered by a user, the method further comprises:
obtaining application scenario information of a conversation service scenario provided by the developer, the application scenario information including intent information, parameter information and corresponding execution actions;
building the conversation system having a basic service logic, according to the application scenario information.

17. The computer readable storage medium according to claim 13, wherein before, at the same time as or after obtaining a sample adjusting instruction triggered by a user, the method further comprises:
obtaining verification effect data of the conversation system according to the input information;
outputting the verification effect data.

18. The computer readable storage medium according to claim 13, wherein said at least one adjustment option includes a specific option for outputting a Graphical User Interface, for the user to perform global view.
